(19) United States
(12) Patent Application Publication
(10) Pub. No.: US 2008/0066810 A1
(43) Pub. Date: Mar. 20, 2008

(54) ANTI-SIPHON CONTROL VALVE

(75) Inventor: Swi Barak, Caesarea (IL)

Correspondence Address: FERENCE & ASSOCIATES LLC, 409 BROAD STREET, PITTSBURGH, PA, 15143, US

(73) Assignee: Casearea Medical Electronics, Ltd., Caesarea (IL)

(21) Appl. No.: 11/852,249

(22) Filed: Sep. 7, 2007

Related U.S. Application Data
(60) Provisional application No. 60/824,783, filed on Sep. 7, 2006.

(51) Int. Cl. F16K 17/26; F16K 15/14

(52) U.S. Cl. 137/493.8; 137/859

(57) ABSTRACT

An anti-siphon control valve includes a housing fitted with a first port inflow, being in fluid communication with a first chamber; a second port outflow, being in fluid communication with a second chamber coaxial with the first chamber. A fluid flow path extends between the chambers. A resilient membrane is tensioned over the fluid flow path and over chamber so as to close the fluid flow path. The membrane has one face exposed to atmospheric pressure. The arrangement is such that when differential pressure across the membrane exceeds predetermined pressure threshold the membrane flexes and opens the fluid path allowing fluid flow between the first chamber and the second chamber. The scope of the invention will be pointed out in the appended claims.

### CLAIM FOR PRIORITY

This application claims priority from U.S. Patent Application No. 60/824,783, filed on Sep. 7, 2006, which is fully incorporated by reference as if fully set forth herein.

### FIELD OF THE INVENTION

The present invention is in the field of fluid flow control valves, such as for use in medical administration sets.

### BACKGROUND OF THE INVENTION

It is often required to provide an anti-siphon control valve which operates within a specific pressure range. An example of such an instance is a set for administrating medical liquids to a patient, in which a container holding the liquid is supported by a stand at a height of typically about two meters or at times being provided within a pressure device.

It is required to ensure that liquid contained within the container freely flows in a direction towards the patient and to prevent flow in an opposite direction, i.e., in a direction from the patient. A variety of liquid flow valves are known. Typical prior art flow valves are fitted on a fluid supply line and comprise a membrane sealingly engaging a closure between an upstream portion and a downstream portion of the supply line, which upon exposure to a predetermined pressure, the membrane deforms to open a flow path towards the upstream portion.

By another example, the membrane comprises one or more apertures such as pre-pierced or pre-slotted apertures which in a non-deformed position, the apertures are closed. However, upon deformation of the membrane under a predetermined pressure, the apertures open and liquid flow is enabled through the supply line.

Typically anti-siphon flow control valves are unidirectional, i.e., permitting flow from an inlet port towards an outlet port but not vice versa. In cases where the valve is bi-directional, then the pressure required to initiate flow is typically identical in both directions of operation. Other types of flow valves are of complex structure and are provided with mechanical components such as springs, gaskets and pistons and thus render the valve complex and of essentially high costs. Therefore, many of the known anti-siphon control valves are not provided with priming means and where such means are provided, there are no arrangements for retaining the priming means in their priming position, but rather it is required to manually keep the priming means depressed.

Thus, a need has been recognized to provide an improved fluid flow anti-siphon control valve in which the above referred to drawbacks are essentially reduced or overcome.

### SUMMARY OF THE INVENTION

In accordance with at least one presently preferred embodiment of the present invention, there is broadly contemplated an improved anti-siphon control valve.

One aspect of the present invention provides an anti-siphon control valve comprising: a housing comprising: a first fluid source; and a second fluid source; a membrane tensioned over a rimmed annular edge separating the first fluid source from the second fluid source; wherein, upon exposure to differential pressure across the membrane, the membrane is displaced and permits fluid flow between the first fluid source and the second fluid source.

For a better understanding of the present invention, together with other and further features and advantages thereof, reference is made to the following description, taken in conjunction with the accompanying drawings, in which like reference numerals are used to identify the same or similar parts in several views, and the scope of the invention will be pointed out in the appended claims.

### BRIEF DESCRIPTION OF THE DRAWINGS

FIG. 1. is a longitudinal cross-section of the valve according to the present invention, the valve is in its closed position.

FIG. 2. is a longitudinal cross-section of the valve according to the present invention, the valve is in its open position, with a priming retainer in its locked position.

### DESCRIPTION OF THE PREFERRED EMBODIMENTS

In order to understand the invention and to see how it may be carried out in practice, preferred embodiments will now be described, by way of a non-limiting examples only, first generally and then with reference to the accompanying drawings.

It will be readily understood that the components of the present invention, as generally described and illustrated in the figures herein, may be arranged and designed in a wide variety of different configurations. Thus, the following more detailed description of the invention, as presented in the figures, is not intended to limit the scope of the invention claimed, but is merely representative of selected embodiments of the invention.

Reference throughout this specification to “one embodiment” or “an embodiment” (or the like) means that a particular feature, structure or characteristic described in connection with this embodiment is included in at least one embodiment of the invention. Thus, appearances of the phrases “in one embodiment” or the like in various places throughout the specification is not necessarily referring to the same embodiment.

Furthermore, the described features, structures, or characteristics may be combined in any suitable manner in one or more embodiments. In the following description, numerous specific details are given to provide a thorough understanding of embodiments of the invention. One skilled in the relevant art will recognize, however, that the invention can be practiced without one or more of the specific details, or with other components, materials, etc. In other instances, well-know structures, materials, or operations are not shown or described in detail to avoid obscuring aspects of the invention.

The disclosure will now provide an overview of the invention before providing a more detailed description of the invention.

One embodiment the present invention provides an anti-siphon fluid control valve comprising a housing fitted with a first port inflow being in fluid communication with a first chamber; a second port outflow, being in fluid communication with a second chamber coaxial with the first chamber; a fluid flow path extending between the chambers; a resilient membrane tensioned over the fluid flow path and over the chamber so as to close the fluid flow path, said membrane having one face thereof exposed to atmospheric pressure, the arrangement being such that when differential pressure across the membrane exceeds a predetermined pressure threshold, the membrane flexes and opens the fluid flow path allowing fluid flow between the first chamber and the second chamber.

Preferably, the valve is formed with a priming member for manually displacing the membrane to disengage from the fluid flow path and open it. Preferably, the priming member is a stem projecting from a wall of the first chamber connected to other portions of the first chamber via a flexible zone, whereby displacing the wall towards the membrane entails displacing the membrane and priming the valve. Preferably, the priming member is biased to disengage from the membrane. By one of its designs, the flexible zone of the first chamber is resilient and is biased to resume its original shape.

Preferably, the valve further comprises a retention member for retaining the priming member in its displaced position, thereby keeping the fluid flow path open. By one application of this preferred embodiment, there is further provided a locking arrangement for arresting the retention member in a position in which the fluid flow path is kept open.

Preferably, the first port and the second port coaxially extend from the housing along an axis normal to the axis of the chambers. The retention member is a bridge-like element comprising a retaining portion for engaging the wall portion, and two arms, each engaged with one of the first or second port, respectively, and being rotatable about the port's axis.

Preferably, the first chamber is a well-like enclosure having a bottom wall portion communicating with other portions of the first chamber via a flexible zone. A top, rimmed edge separates between the first and second chambers and forms the fluid flow path and over which the membrane is tensioned.

The housing further preferably comprises a venting cover positioned in close proximity to the flexible membrane whereby, in its flexed state, the membrane bears against the venting cover. The venting cover is fitted with one or more venting apertures. Among its tasks, the venting cover also secures the membrane to the housing along a peripheral edge thereof. Preferably, in order to avoid blocking of the one or more venting apertures upon flexing of the membrane, the one or more apertures are preferably formed at peripheral portions of the venting cover.

In an embodiment of the present invention, the valve can be arranged to contain an orifice and a second flow chamber having different areas in contact with the flexible membrane to establish in effect a bi-directional valve that shall open in one direction with excessive pressure difference, hence turning the valve into a uni-directional valve. The valve can be arranged to further comprise a priming member for manually displacing the membrane to disengage from the fluid flow path. The priming member may be a stem projecting from a wall portion of the first chamber whereby displacing the wall towards the membrane entails priming of the valve.

The wall portion of the first chamber may be flexible and connected to other wall portions of the first chamber. The flexible wall is resilient and can resume its original shape. The priming member may be biased to disengage the membrane. The valve may contain a retention member for retaining the priming member in its displaced position, thereby keeping the fluid flow path open. The valve may contain a locking arrangement for arresting the retention member in a position in which the fluid path is kept open.

The valve can be arranged such that the first port and the second port co-axially extend from the housing along an axis normal to the axis of the chambers, and where the retention member is a bridge like element having a retaining portion for engaging the priming member, and two arms each engage with one of the first or second ports, being rotatable about the ports' axis.

The valve can be arranged such that the first chamber is a well like enclosure having a flexible zone that can be deformed at a bottom wall and a top rimmed edge forming the fluid flow path and over which the membrane is tensioned. The difference between the orifice in communication with the surface of the membrane and the area of the second chamber in communication with the surface of the second membrane entail different pressures required to deform the membrane, and thus constitute in effect a uni-directional valve, having fluid flow from the inflow port towards the outflow port.

The valve can further comprise a venting cover positioned in close proximity to the flexible membrane whereby in its flexed state the membrane bears against the venting cover, the venting cover fitted with one or more apertures. The pattern of the cross-section of the membrane can be U-shaped such that it caps the venting cover with an exact fit. The one or more apertures of the venting cover may be at the periphery of the venting cover. The second chamber of the valve may be in the shape of an annulus detached from the first chamber. A system of a peristaltic pump and an administration set, baring the valve described above, will pre-detect (indicate) the event of a user forgetting the lever is connected at the locking arrangement; detection should occur automatically before the pump starts operation based on the pressure (lack of pressure) the valve mounted below the pump will indicate.

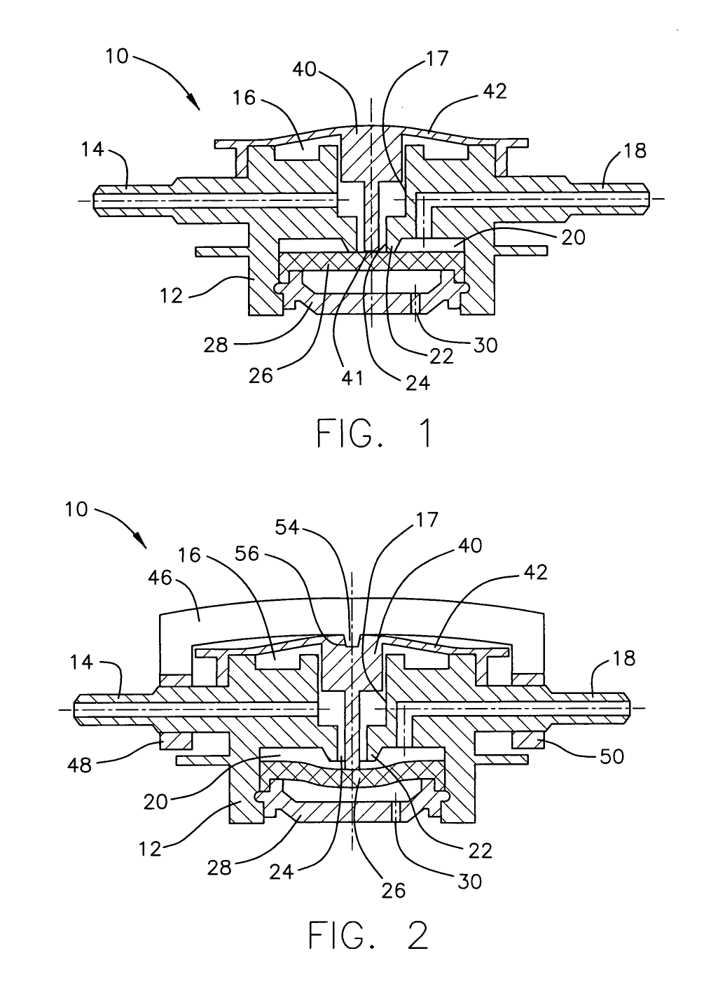

Attention is now directed to FIGS. 1 and 2 of the drawings illustrating a valve (10) comprising a cylindrical housing (12) formed with a first, inlet port (14) extending into a first, inlet chamber (16), the latter being coaxial with the housing (12). The first chamber (16) is formed by a well-like member (17) snapingly engaging the housing (12).

A second outlet port (18) is coaxial with the inlet port (14) and extends into a second, outlet chamber (20), which in fact is in the shape of an annulus which is coaxial with the first chamber (16), and which have a common separating wall (22) terminating at a rimmed annular edge (24) which defines a fluid flow path between the first and second chambers as will hereinafter be explained.

A resilient membrane (26) is securely attached to the housing (12) by a venting cover (28) snapingly fitted to the housing (12), where the membrane (26) sealingly bears against the rimmed annular edge (24), thus sealing the first and second chambers (16) and (20) respectively, and the flow path (24) extending between the chambers.

As can be seen in FIG. 1, the venting cover (28) is fitted with a venting aperture (30) at a peripheral portion of the cover, for the reason to become apparent hereinafter. It will further be noted that the venting cover (28) is in close proximity to the membrane (26), though leaving a clearance there-between, wherein atmospheric pressure exists.

A stem-like priming member (40) extends from a flexible bottom wall portion (42) of the first chamber (16), said stem-member (40) extending almost towards a bottom surface of the membrane (26) leaving a clearance between its upper end (41) and membrane (26).

A retention member (46) has a bridge-like shape with two annular portions (48) and (50) rotatably engaged over inlet port (14) and outlet port (18), respectively. A bridging portion (46) has a central portion thereof containing a bulge (54) for engagement with a depression (56) formed at a lowermost, central portion of the well-like portion (17).

Further attention is now directed to FIG. 2 of the drawings in which the anti-siphon valve is shown in its locked and open position after applying pressurized fluids through inlet port (14) entailing flexion of the membrane (26) to disengage the rimmed annular edge (24), thus opening the fluid flow path between the first, inlet chamber (16) and the second, outlet chamber (20), permitting fluid egress via outlet port (18).

It will be noted that in the open position of the valve, as seen in FIG. 2, the membrane (26) bears against a central portion of the venting cover (28) while the venting aperture (30) remains unblocked, thus ensuring that the space remains at atmospheric pressure.

A person versed in the art will have no difficulty in realizing that the first and second ports and the first and second chambers may change their functions, respectively, i.e. the second port (18) may serve as an inlet port and the first inlet port (14) may serve as an outlet port with the second chamber (20) serving as an inlet chamber and the first chamber (16) serving as an outlet chamber, respectively. It will further be appreciated by a skilled person that changing the cross-sectional area of the diaphragm (26) over the first chamber (16) or over the second chamber (20) will determine the differential pressure required for opening the valve. Accordingly, the valve may be used as a uni-directional valve or as a Bi-directional valve with equal or different pressures required for opening the valve in either direction.

Attention is again directed to FIG. 2 of the drawings. In certain instances, it is required to prime a valve, e.g. to drain gases from a liquid supply line or to rinse a supply line prior to administrating fluids. A non-limiting example where such priming means are required are valves used in medical liquid administration.

When it is required to momentarily prime the valve, the bottom portion (42) of well-like member (17) of the first chamber (16) is depressed upwards against the resiliency of the resilient annular segment (42), whereby the top end (41) of priming member (40) encounters the membrane (26) and deforms it to the position seen in FIG. 2, i.e., opening the flow path (24) between the chambers, enabling flow through the valve.

However, when it is required to retain the valve (10) in its primed position, i.e., when the pressure through the inlet port does not reach the predetermined pressure threshold, then it is possible to open the valve and keep it in its open position by swinging the retention member (46) into the position seen in FIG. 2 in which the well-like member (17) of the first chamber (16) is depressed, thus entailing deformation of membrane (26) into its open position. In order to ensure that the valve remains in its open position, bulge (54) snaps into depression (56) thus ensuring that the retention member (46) does not swing out of engagement with the bottom portion of the well-like member (17).

It will be appreciated to a person versed in the art that the design of the housing may be different than the specific design illustrated herein, e.g. the manner in which the venting cover and the bottom portion are engaged with the housing, location of resilient portion, etc., mutatis mutandis. It will further be appreciated that the valve according to the present invention may be a bi-directional valve and the cross-sectional area of the membrane over the first chamber may be similar or different to the cross-sectional area of the membrane over the second chamber, whereby the differential pressure required to open the flow path in one direction may be different than the differential pressure required to open the flow path in the other direction.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An anti-siphon control valve comprising:
a housing comprising:
a first fluid source; and
a second fluid source; and
a membrane tensioned over a rimmed annular edge separating the first fluid source from the second fluid source;
wherein, upon exposure to differential pressure across the membrane, the membrane is displaced and permits fluid flow between the first fluid source and the second fluid source.

2. The anti-siphon control valve according to claim 1, wherein a surface of the membrane has different areas in contact with the first fluid source and the second fluid source, wherein only unidirectional fluid flow is permitted.

3. The anti-siphon control valve according to claim 1 further comprising a priming member in contact with the housing for displacing the membrane.

4. The anti-siphon control valve according to claim 3 wherein the priming member contains a stem projecting towards the membrane.

5. The anti-siphon control valve according to claim 4 wherein the priming member is flexible.

6. The anti-siphon control valve according to claim 4 wherein the priming member is biased to displace the membrane.

7. The anti-siphon control valve according to claim 5 wherein the priming member is resilient and has an initial shape and resumes the initial shape after being displaced.

8. The anti-siphon control valve according to claim 3 further comprising a retention member for keeping the priming member in a displaced position thereby permitting fluid flow between the first fluid source and the second fluid source.

9. The anti-siphon control valve according to claim 8 further comprising a locking arrangement for arresting the retention member in a position permitting fluid flow between the first fluid source and the second fluid source.

10. The anti-siphon control valve according to claim 8 wherein the retention member is a bridge-like element having a retaining portion for engaging the priming member and a plurality of arms, wherein the plurality of arms engage the housing.

11. The anti-siphon control valve according to claim 1 wherein the first fluid source is well-like in shape and further wherein the first fluid source has a flexible bottom wall and a top rimmed edge forming a fluid flow path over which the membrane is tensioned.

12. The anti-siphon control valve according to claim 1 further comprising a venting cover having at least one aperture and engaging the housing, placed in close proximity to the membrane, whereby upon displacement of the membrane, the membrane contacts the venting cover.

13. The anti-siphon control valve according to claim 13 further wherein the membrane, upon displacement, contacts the venting cover with an exact fit.

14. The anti-siphon control valve according to claim 12 wherein the one or more apertures are formed at peripheral portions of the venting cover.

15. The anti-siphon control valve according to claim 1 wherein the second fluid source is in the shape of an annulus detached from the first fluid source.

16. The anti-siphon control valve according to claim 1 further comprising a pressure valve mounted below the pump for detecting automatically the pressure within the valve for ascertaining if the locking arrangement on the retention member is engaged.
